(19) United States
(12) Patent Application Publication
(10) Pub. No.: US 2010/0220750 A1
(43) Pub. Date: Sep. 2, 2010

(54) Terahertz Laser Components And Associated Methods

(76) Inventor: James Hayden Brownell, Wilmington, DE (US)

Correspondence Address: LATHROP & GAGE LLP, 4845 PEARL EAST CIRCLE, SUITE 201, BOULDER, CO, 80301, US

(21) Appl. No.: 12/089,878

(22) PCT Filed: Jul. 19, 2006
(86) PCT No.: PCT/US06/28066

§ 371 Date: May 18, 2010

Related U.S. Application Data
(60) Provisional application No. 60/700,619, filed on Jul. 19, 2005.

(51) Int. Cl. H01S 3/094; G21K 5/00; G21K 5/04; G02B 5/18; H01S 3/30

(52) U.S. Cl. 372/4; 250/504 R; 359/574

(57) ABSTRACT

A system generates FIR radiation. An electron source generates an electron beam. A first horn interacts with the electron beam to produce the FIR radiation. A second grating horn receives the electron beam from the first horn and emits it as a collimated free wave or Smith-Purcell radiation.

### RELATED APPLICATIONS

This application claims the benefit of priority to U.S. Application No. 60/700,619, filed Jul. 19, 2005, which is incorporated herein by reference.

### GOVERNMENT LICENSE RIGHTS

The U.S. Government has certain rights in this invention as provided for by the terms of Grant No. DAAD 19-99-1-0067 awarded by the Army Research Office, and Grant No. ECS-0070491 awarded by the National Science Foundation.

### BACKGROUND

Humans have developed extensive technology to generate and detect electromagnetic waves or vibrations throughout the electromagnetic spectrum—from the short wavelengths and high frequencies of gamma rays to the long wavelengths and low frequencies of radio waves. The exception to this technological know-how occurs within the far infrared (“FIR”) or terahertz gap, which exists between infrared light and millimeter wavelength microwaves. This gap is identified by electromagnetic energy with free space wavelengths of about 10 to 1000 micrometers (μm). In the FIR gap, various sources and detectors exist but they are not practical, e.g., they lack intensity, frequency-tuning ability and/or stability.

The most successful FIR sources, to date, utilize the Smith-Purcell (S-P) effect, which can be viewed as the scattering of an electron's evanescent wake field from a grating. The wavelength (λ=2πc/ω) of the emitted radiation is dependent on the grating period (l), electron velocity (υ), and emission angle relative to the beam direction (θ), by the so called S-P relation:

$$λ = \frac{l}{m} ( \frac{c}{v} - cos θ ) , \qquad ( 1 )$$

where m is the diffraction order of the emission. This relation has been confirmed for spontaneous S-P radiation experiments spanning the visible, THz, to microwave spectrum.

The S-P effect was first utilized in terahertz lasers during the 1980's by the late Professor John Walsh at Dartmouth College and others. Radiation sources were developed to produce electromagnetic radiation at FIR frequencies in a tunable fashion. The devices utilized planar diffraction gratings and showed that small, compact and relatively inexpensive tabletop free electron lasers could be commercially practiced devices for the generation of FIR electromagnetic waves. See, e.g., U.S. Pat. Nos. 5,263,043 and 5,790,585, each of which is hereby incorporated by reference.

WO 2004/038874, which is hereby incorporated by reference, disclosed improvements to terahertz radiation sources, where the planar diffraction gratings utilized by Walsh were replaced by grating horns. The grating horns confined and focused the electron beam to provide terahertz radiation with improved power output.

### SUMMARY

In one embodiment, a diffraction grating element includes a pair of optical horns, which are diametrically opposed to one another such that radiation exiting a first horn enters a second horn. The first horn is ruled with a grating period, such that an electron beam interacting with the grating period produces terahertz radiation.

In one embodiment, a system for generating FIR radiation includes an electron source for generating an electron beam and a pair of optical horns, which are diametrically opposed to one another such that radiation exiting a first horn enters a second horn. The first horn is ruled with a grating period and interaction between the electron beam and the grating period produces the FIR radiation.

In one embodiment, a method for generating FIR radiation, includes generating an electron beam and focusing the electron beam to a pair of diametrically opposed optical horns, wherein one of the optical horns is ruled with a grating period and interaction between the electron beam and the grating period produces the FIR radiation.

### BRIEF DESCRIPTION OF THE FIGURES

FIG. 1 schematically illustrates one Smith-Purcell Free Electron Laser.

FIG. 2 depicts an exemplary relation between power and beam current for the grating within the Smith-Purcell Free Electron Laser of FIG. 1.

FIG. 3 shows one planar grating horn.

FIG. 4 shows one grating horn.

FIG. 5 depicts graphs of radiated power vs. beam current for an array of planar grating horns.

FIG. 6 depicts graphs of radiated power vs. beam current for a 20° grating horn and for a planar grating horn.

FIGS. 7-13 depict alternative embodiments of grating horns.

FIG. 14 shows one system for interacting particles with coherent radiation.

FIGS. 15-17 illustrate embodiments with two grating horns diametrically opposed.

FIGS. 18-19 illustrate separation of two diametrically opposed grating horns by a window, according to several embodiments.

### DETAILED DESCRIPTION

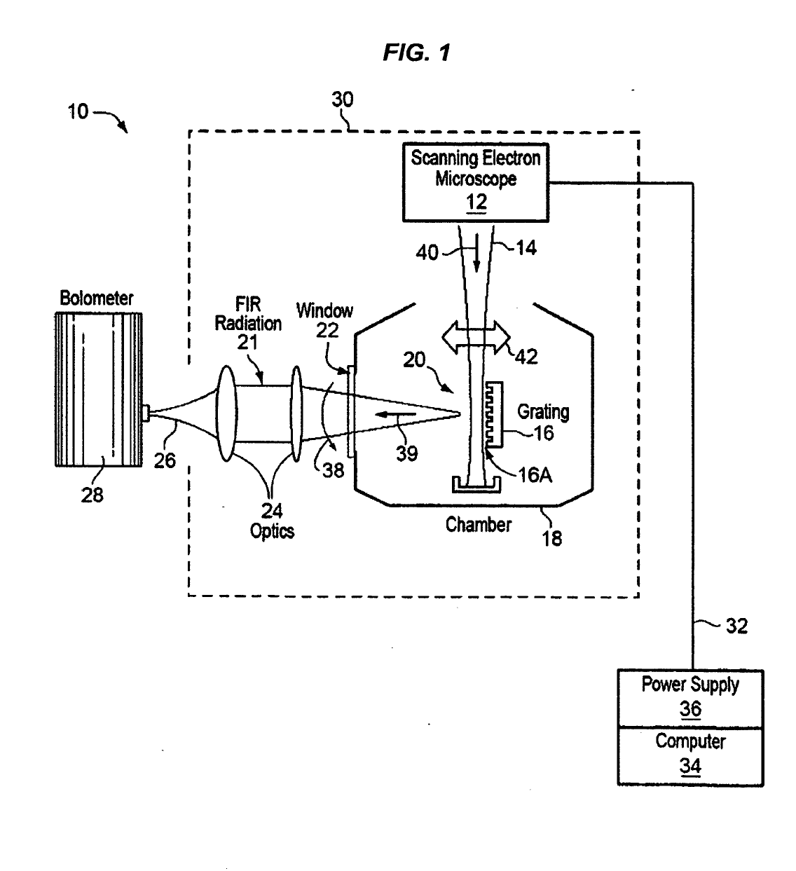

FIG. 1 depicts one embodiment of a free electron laser 10. A scanning electron microscope (SEM) 12 generates an electron beam 14. A grating 16 (illustratively mounted on a specimen stage within a specimen chamber 18) is positioned at the beam focus 20 of electron beam 14. FIR energy 21 scatters from grating 16 and exits chamber 18 through a window 22, for example made from polyethylene. Optics 24 (e.g., a pair of TPX (tetramethyl-1-pentene) lenses that exhibit optical refraction characteristics to FIR radiation 21) may be used to focus energy 21 into a laser beam 26. FIG. 1 also illustratively shows a detector 28 (e.g., a bolometer) that may be used to detect radiation of laser beam 26.

The size of grating 16 may affect the overall size of laser 10, which may for example be formed into a hand-held unit 30 attached by an umbilical 32 (e.g., containing electrical wiring and data busses) to a computer 34 and power supply 36. For example, power supply 36 operating within a range of 10-100 kV (υ/c=0.1-0.7) may be used to accelerate electron beam 14 to grating 16.

An emission angle 38 of FIR radiation 21 is for example about 20 degrees about a normal to grating 16; this produces continuously tunable FIR radiation 21 over a wavelength range of 1.5 to 10 times the grating period (on a first order basis, as described below). Coverage may be extended by blazing the grating for higher orders and/or mounting several gratings of different periods on a rotatable turret (i.e., a plurality of gratings, each of the plurality of gratings rotatable to beam focus position 20 and having a different periodicity).

Certain advantages may be appreciated by laser 10 as compared to the prior art. For example, laser 10 may be made as a portable unit 30 so that users can easily use FEL 10 within desired applications. In another example, laser output 26 from laser 10 may be tunable, narrowband, polarized, stable, and have continuous or pulsed spatial modes. See, e.g., J. E. Walsh, J. H. Brownell, J. C. Swartz, J. Urata, M. F. Kimmitt, Nucl. Instrum. & Meth. A 429, 457 (1999), incorporated herein by reference.

The evanescent field from beam 14 decays exponentially with distance from the electron beam's trajectory (i.e., along direction 40) with an e-folding length equal to λυ/2πc for non-relativistic beam energy. In one embodiment, therefore, the electrons of beam 14 pass within the e-folding length of the surface 16A of grating 16, so that the field strength is sufficient to scatter FIR radiation 21, as shown. Reflection from grating surface 16A back onto the electrons of beam 14 may also provide laser amplification feedback, so that gain is sensitive to beam height 42 above grating 16. For a 30 kV beam 14, the e-folding length is sixteen micrometers for 1 THz (300 micrometer) radiation 21. This in turn causes stringent requirements on the diameter of electron beam 14; and this constraint is tighter for shorter wavelengths (i.e., less than 300 μm). Accordingly, laser interaction may be optimized through resonator design and beam focusing, as now discussed.

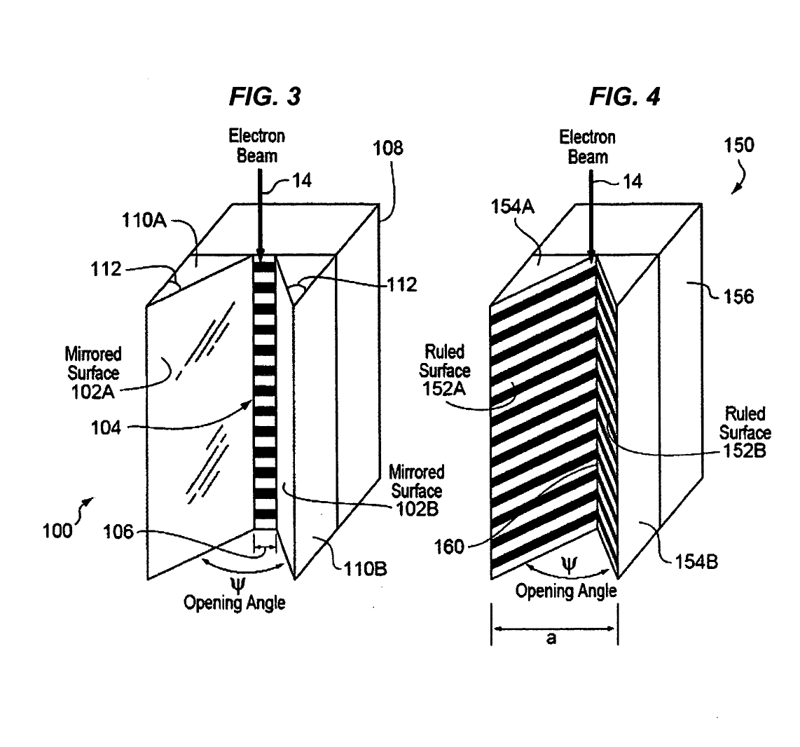

In one embodiment, grating 16 has a planar grating cut into the top of an aluminum block one centimeter long and a few millimeters wide to form a laser resonator, as in FIG. 3. See also, e.g., J. Urata, M. Goldstein, M. F. Kimmitt, A. Naumov, C. Platt, J. E. Walsh, Phys. Rev. Lett. 80, 516 (1998), incorporated herein by reference. With this configuration, there need not be mirrors or other external optics involved. In particular, electromagnetic energy travels slowly enough along grating 16 to grow significantly from grating feedback alone.

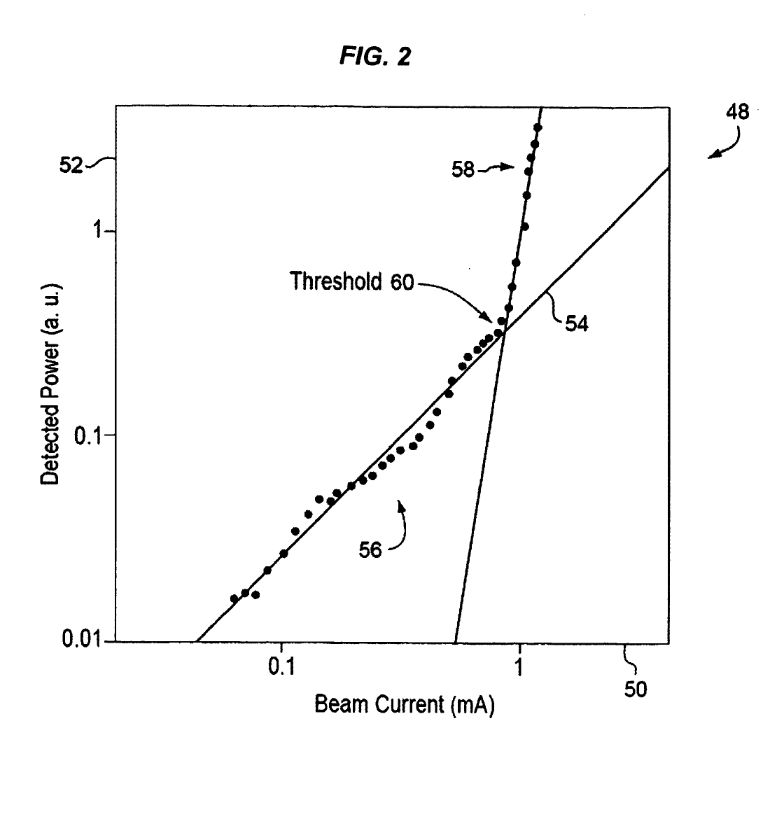

To illustrate this point, radiated power may be plotted against the beam current, as shown by graph 48 of FIG. 2, which shows a typical measurement for a planar grating, see, A. Bakhtyari, J. E. Walsh, J. H. Brownell, Phys. Rev. E 65, 066503 (2002), which is incorporated by reference herein. In FIG. 2, x-axis 50 represents beam current while y-axis 52 represents detected power (a.u.). As shown in graph 48, the coupling strength grows with current and so output power also rises monotonically with current. The proportionality between current and power (slope 1 on plot 54) indicates spontaneous emission while a super-linear response implies amplification. The signature of a gradual rise 56 followed by a steep rise 58 defines the laser threshold 60. In FIG. 2, the data at 0.5 THz was produced with 29 kV and a relatively broad 40 micrometer diameter beam 14. Using a planar grating 16 described above, the performance yielded 1 microwatt power and 1.5 THz.

The wiggle evident in the sub-threshold region (i.e., along gradual rise 56) is likely caused by beating between coexistent waves on grating 16. See, e.g., Bakhtyari et al., 2002. This observation confirms the physical basis for the gain mechanism; these wiggles would not appear unless significant loss occurred, the primary source of loss being radiation 21. Other loss may be reduced by enclosing the resonator with roof and walls, such as in traveling-wave tubes at microwave frequencies. But, in so doing, some tunability may be sacrificed. Therefore, closure of the resonator is not usually beneficial. Other remedies for loss are to enhance the gain (as discussed above) and to improve output coupling.

The pattern of radiation 21 varies as the cosine squared of the azimuthal angle, normal to the beam direction 39 (see FIG. 1). See also, P. M. van den Berg, J. Opt. Soc. Am. 63, 1588 (1973), incorporated herein by reference. Given that optics 24 generally collect radiation 21 within a relatively small azimuthal range of angles 38, focusing radiation 21 as it leaves grating surface 16A will magnify the collectible intensity; but it is nonetheless preferable that the focusing elements do not disturb the dispersion described by the S-P relation of Equation 1 or else the power spectrum will be diffuse and brightness will diminish.

One solution (a grating horn antenna as in FIG. 4) is based on a horn antenna. See, C. A. Balanis, Antenna theory, analysis and design, 2nd ed., John Wiley, New York, 1997, Section 13.3, incorporated herein by reference. A “horn” is the flared end of a hollow waveguide that enlarges the effective mode area in order to reduce diffraction effects. The waveguide then transmits or receives free propagating waves more efficiently. One horn has a linear flare forming, in the case of a rectangular waveguide, a pyramidal shape of four intersecting planes. The pertinent dimensions are the width of the horn's mouth (a) and its full opening angle (ψ). If the width of the inlet is smaller than the wavelength, then a near diffraction limited light beam is directed along the horn bisecting axis with full divergence angle φ≈sin⁻¹(4λ/a) for sufficiently large a. Increasing the inlet width increases φ, reduces magnification, and adds complicated structure to the radiation lobe.

The minimum spread, and therefore the greatest magnification of the peak intensity (i.e., peak horn directivity), occurs when the diffraction angle equals half the opening angle. This implies a constraint on the length (d) from the throat to the opening of the horn:

d∃2λ/tan(ψ/2)sin(ψ/2) (2)

The input power is independent of ψ so peak intensity varies inversely with the opening angle. The maximum magnification is then limited by the greatest practical horn depth.

FIG. 3 depicts one planar grating horn (PGH) 100. In the example of FIG. 3, PGH 100 has two planar intersecting mirrors 102A, 102B, with specified opening angle ψ therebetween, and a grating 104 embedded in the crease, parallel to the axis of intersection. The spacing 106 between mirrors 102A, 102B at the grating surface is usually less than one wavelength to provide optimal magnification, simple emission lobe structure, and minimal divergence angle φ for a given horn length d. Mirrors 102A, 102B of PGH 100 can fold the full emission lobe into the range of opening angle ψ, thereby enhancing the emitted intensity without altering the longitudinal angular dispersion expected from grating 104. The expected magnification over PGH 100 is then the ratio of the opening angle ψ to 180 degrees. In addition, mirrors 102A, 102B can maintain independent components of polarization, TM (radial electric field) and TE (azimuthal electric field).

The S-P interaction of Equation 1 generates mainly TM polarization and so PGH 100 functions like an H-plane sectoral horn (see Balanis, 1997). To construct PGH 100, the grating surface 104 was ruled first in a suitable metal block 108. A pair of wedged blocks 110A, 110B (each with a wedge angle 112) with polished inner surfaces (forming mirrors 102A, 102B, respectively) were clamped so as to contact the surface of grating 104 separated by at least the width of electron beam 14. The opening angle of PGH 100 is then twice the wedge angle 112.

PGH 100 may for example incorporate opening angles ψ of 20, 40, 90, and 180 degrees (i.e., no horn) under similar beam conditions; other angles ψ may be chosen as a matter of design choice. To ease beam alignment during experimental testing, the separation between horn walls was 800 micrometers (20% wider than a wavelength). The results are shown in FIG. 5 with the opening angle indicated for each case (the electron beam 14 used in the testing of FIG. 5 was 29 kV with a beam waist of 58 μm). The measured power ratios for the first three cases of 6, 4, and 1.6 relative to the planar grating are 70% to 90% of the expected values. The full collection angle of the detection system (e.g., a bolometer 28, FIG. 1) was twelve degrees so that the measured power corresponded to the peak intensity for the larger openings. The smallest opening ψ (twenty degrees) produces a ten degree lobe (e.g., defined within angle 38, FIG. 1) so the measured power is an average over the lobe and less than the peak intensity. Since consistent alignment of beam 14 along the horn vertex was difficult to maintain, slight variations may have caused reduced magnification.

In one embodiment, the horn may also be ruled. That is, the grating may be wrapped about beam 14 to enhance the proximity of beam 14 to the grating surface, thereby improving coupling. The grating shape may also be chosen so as not to affect the S-P dispersion relation of Equation 1. Ruling the horn can combine the focusing effect of the horn with the enhanced feedback from partial closure. A ruled horn has all of the emission characteristics of the H-plane sectoral horn described above and supports evanescent modes traveling synchronously with the electron beam. The region near the horn vertex of significant evanescent field strength expands with decreasing horn opening angle. Increasing the evanescent region allows greater overlap of a circular electron distribution and electric field and improved collimation of the electron beam, both of which contribute to greater energy transfer and improved laser performance. A new structure formed in this manner is termed a grating horn (GH), such as shown by GH 150 in FIG. 4.

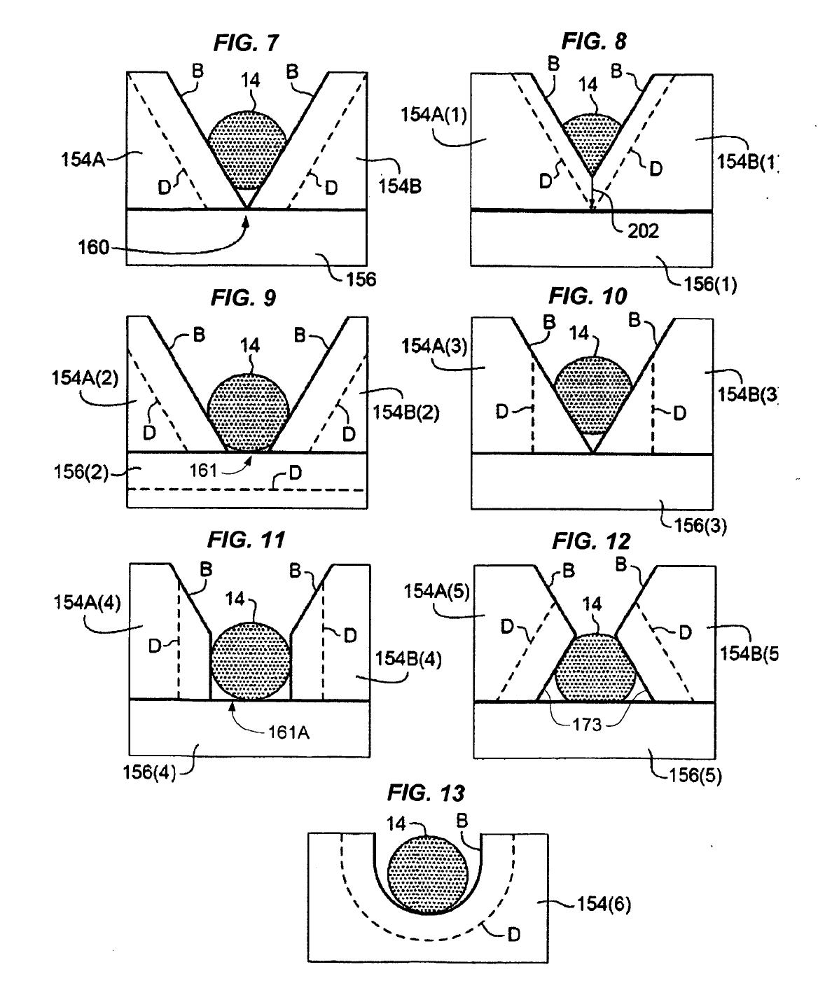

GH 150 is distinct from the shallow, gradual concavity depicted in FIGS. 16 and 7B of U.S. Pat. Nos. 5,268,693 and 5,790,585, respectively. In the latter case, the grating surface conforms to a broad, elliptical electron beam. Because the coupling strength decays exponentially away from the grating surface, spreading the beam out into a “ribbon” over a flat surface would improve the emission. But it is difficult to produce and control a spread beam. In contrast, GH 150 uses a circular beam. The primary distinction though is that GH 150 forces the electrons to interact with a single spatially-coherent field mode and generate high-brightness radiation. Regions of a spread beam separated by more than a wavelength can develop independently, thereby diminishing the overall coupling and brightness.

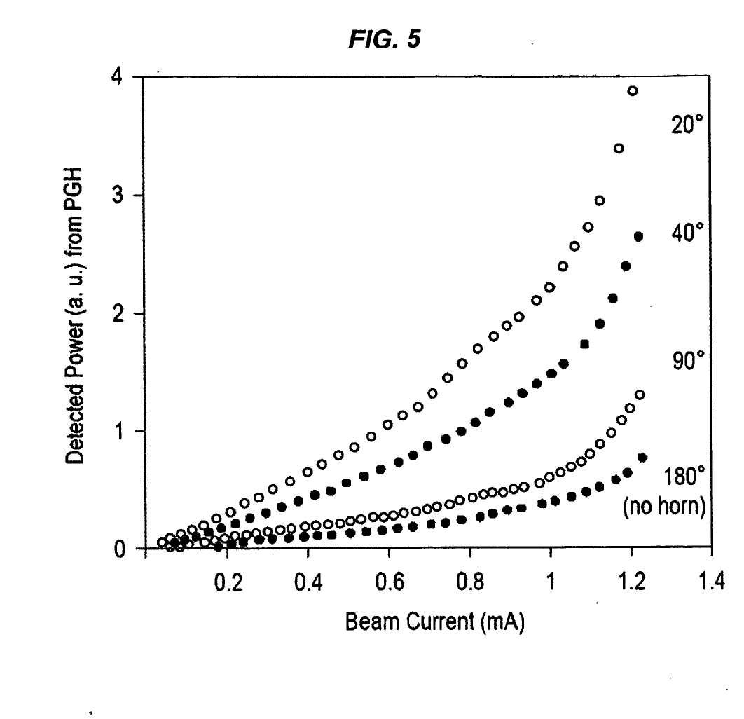

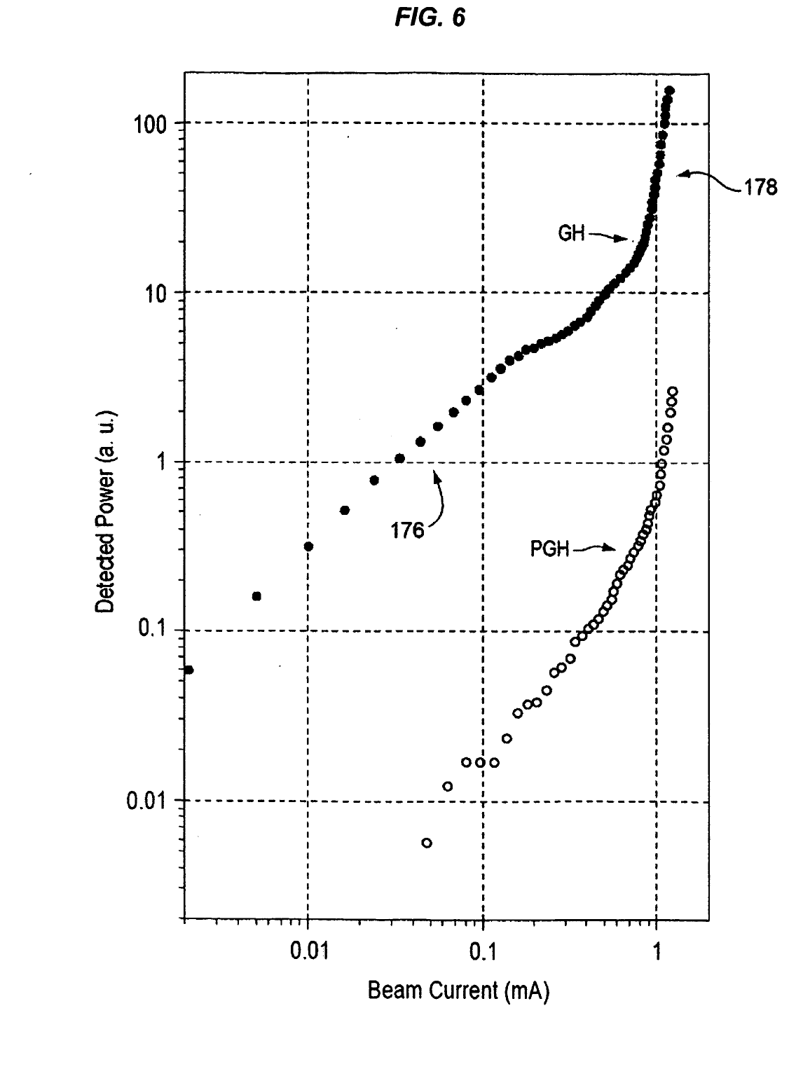

GH 150 was manufactured by ruling two planar gratings 152A, 152B on solid metal blocks 154A, 154B, respectively, with one side beveled at half the opening angle ψ. These blocks 154 may then be clamped to a flat base 156 with rulings of gratings 154A, 154B in contact and aligned so that the gratings are in phase. A GH with a twenty degree opening angle ψ was mounted adjacent to a planar grating (e.g., PGH 100, FIG. 3) of the same dimensions on the SEM specimen stage (i.e., in the setup of FIG. 1). Two beam current scans were conducted consecutively to ensure similar beam characteristics for proper comparison. The resulting data is plotted in FIG. 6, with power from PGH 100 as open circles and power from GH 150 as solid dots. The GH data produced significantly higher collectable power than PGH 100, as shown. Since performance from a GH may be sensitive to the beam trajectory (i.e., the trajectory of beam 14 along direction 40), in one embodiment beam 14 follows a line parallel to a vertex 160 of GH 150 but offset along the horn bisected by roughly one beam radius. If the beam favors one side, then GH 150 acts much like PGH 100. Vertex 160 and blocks 154A, 154B form a V-groove shape through which electron beam 14 passes, as shown in FIG. 7.

Gratings 104, 152A, 152B may be formed from a wide variety of materials. In one embodiment, the material can include a conducting material, such as copper, aluminum, various alloys, gold, silver coated conducting surfaces, or combinations thereof. Higher conductivity can enhance performance of an S-P grating. Other considerations for choosing materials include, e.g., durability; melting point and/or heat transfer, since the grating is bombarded by the electron beam; and machinability, because the grating is typically fabricated by sawing, machining, and/or laser cutting.

The output (i.e., radiation 21) from GH 150 can be similar in characteristic to PGH 100, as shown in FIG. 6 (which utilized a 29 kV beam with a 50 μm beam waist). A low-power linear regime 176 is more distinct because of the increased signal. It oscillates through a subthreshold region and abruptly rises in regime 178, similar to data shown in FIG. 5. The different shape of the oscillation likely stems from different boundary conditions in GH 150 relative to PGH 100. FIG. 6 depicts three pertinent details. First, collectable power is a multiple of at least 40 times greater with GH 150, far higher than the factor of 6 observed with the comparable PGH 100. Second, the multiple expands to 100 fold in the linear regime 176. The experimentation of FIG. 6 proved that GB 150 enhanced spontaneous S-P emission as compared to PGH 100 or other gratings. Third, and most importantly, the multiple expands to 100 fold at the highest power because the threshold current of GH 150 is roughly 170 microamps lower than the planar grating. This indicates that GH 150 does indeed enhance the SP-FEL gain.

Boundary conditions largely determine the SP-FEL gain and can be altered by changing how the grating edges at vertex 160 are prepared. A wide variety of GH configurations may be used as a matter of design choice, a number of exemplary embodiments being depicted in FIGS. 7-13. These embodiments vary the degree of resonator closure and may also provide increased amplification of terahertz radiation, as for grating 152A, 152B depicted in FIG. 4. In each case, a cross-sectional dimension of the electron beam 14 is shown, for purposes of illustration. In FIGS. 7-12, the grating is formed by teeth extending between the beveled surfaces (indicated by B) and the dotted lines (indicated by D). In FIG. 7 (which essentially shows the configuration of GH 150 tested in FIG. 6), the teeth extend from the beveled surface B to the depth D with constant depth. The beveled surfaces of the two blocks 154A, 154B meet at the base 156. In FIG. 8, the teeth similarly have a constant depth; however, the beveled surfaces of the two blocks 154A(1), 154B(1) meet at a distance 202 above the base. In FIG. 9, the teeth in the gratings of the two blocks 154A(2), 154B(2) similarly have a constant depth; however, the blocks 154A(2), 154B(2) do not meet, as shown (accordingly, the vertex in this case includes a flat portion 161). Instead, the base 156(2) has a grating with teeth having a depth extending from B to D.

Teeth need not have constant depth, as shown, for example, in FIG. 10. Teeth can have a “triangular” or nonconstant cross section, in which the teeth have a smaller depth toward the top and a greater depth toward the base. Not shown are related embodiments, in which the blocks have triangular teeth, but the blocks either meet above the base (as in FIG. 8) or the base has a grating (as in FIG. 9). Other shapes are contemplated. FIG. 11, for example, depicts teeth having a “triangular” component and a “rectangular” component (accordingly, the vertex of this configuration is also shown with a flat portion 161A). FIG. 12 depicts an embodiment in which the teeth are ruled with constant depth on a bevel 173 having an acute angle relative to the base 156(5). Teeth can also have nonconstant depth, as described for other embodiments. In an embodiment, the gratings are aligned so that the grating element is fully symmetrical. In another embodiment, the grating elements are not symmetrical. In certain depicted embodiments, the teeth may be ruled in a direction perpendicular to the plane between the blocks 154; however, teeth may be ruled at other angles, as will be appreciated by persons of ordinary skill in the art upon reading and understanding this disclosure.

FIG. 13 shows one other GH having a cylindrical grating curved about the electron beam 14; this may improve coupling between beam 14 and the grating.

Additional grating embodiments are also contemplated, such as those disclosed, e.g., in U.S. Patent Application Publication No. US 2002/0097755 A1, incorporated herein by reference. The gratings may be employed in terahertz sources such as those described in U.S. Pat. Nos. 5,263,043 and 5,790,585. The gratings may also be utilized in terahertz sources employed in systems for studying matter, including biological matter, as disclosed in U.S. patent application Ser. No. 10/104,980, filed Mar. 22, 2002 and incorporated herein by reference.

One advantage of GH 150 (employing, for example, a configuration grating as in FIGS. 7-13), is that the generated FIR radiation 21 may be sufficiently collimated to avoid use of optics 24, FIG. 1, saving cost and complexity. Accordingly, in certain embodiments herein, optics 24 are not utilized in FEL 10.

The grating element pairs of FIGS. 7-12 are typically symmetrical about a normal to the base element (e.g., pair 154A, 154B being symmetrical about a normal to base element 156). In each configuration of FIGS. 7-12, electron beam 14 interacts with the symmetrical grating element pair to produce terahertz radiation 21, as in FIG. 1. The degree of symmetry should be at least sufficient to ensure radiation 21 has the desired properties of brightness and intensity.

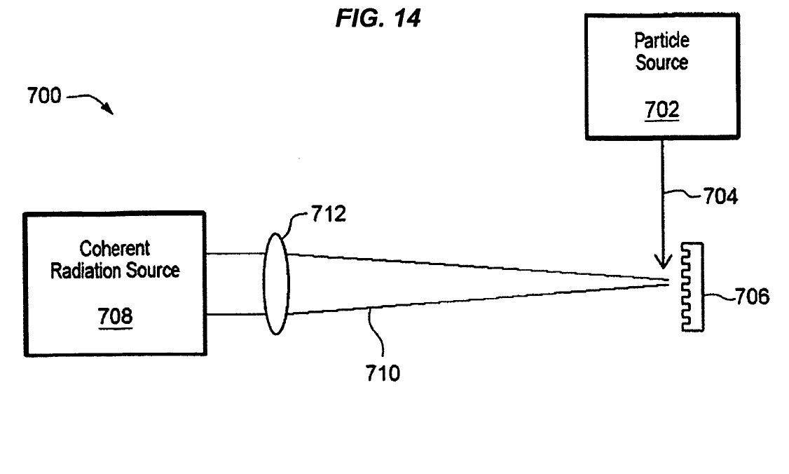

FIG. 14 shows one system for interacting particles with coherent radiation, useful for example in analyzing behavior and physical interaction of the particles with the radiation. A particle source 702 (e.g., an electron generator) generates a particle beam 704 (e.g., an electron beam) towards a grating horn 706 (for example employing a configuration shown in FIGS. 7-13). A coherent radiation source 708 (e.g., a laser such as source 26 depicted in FIG. 1) emits coherent radiation 710 (e.g., terahertz radiation); optics 712 optionally focus radiation 710 to grating horn 706. Beam 704 and radiation 710 then interact so as to excite, modulate and/or stimulate particles of particle beam 704. In one embodiment, the particles are electrons that are accelerated by system 700. In another embodiment, the particles are complicated structures that interact resonantly with incident radiation 710.

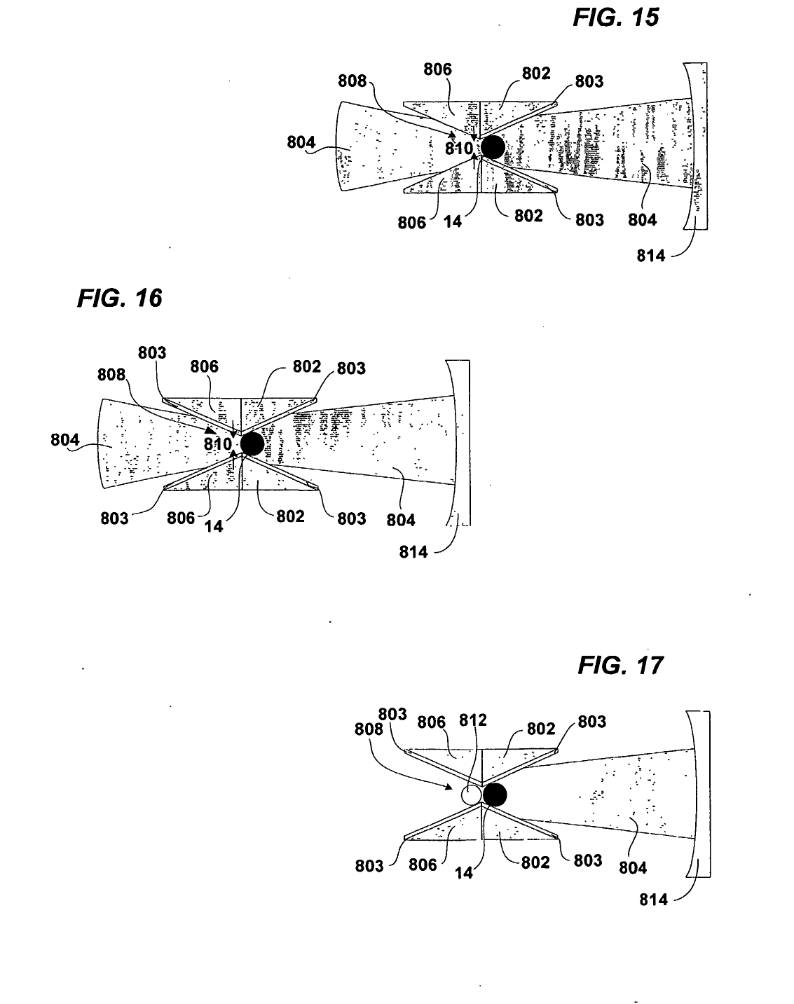

FIGS. 15-17 illustrate embodiments with two horns diametrically opposed. The first horn 802, having grating 803, forms a cavity for electron beam 14. Radiation 804 is confined within the cavity by mirror 814, except that radiation 804 may exit first horn 802 and enter second horn 806 through a physical gap 808. The intensity of electromagnetic radiation excited in the second horn depends on the distance 810 of gap 808 formed between horns 802, 806 and on the surface profile of the output horn, which can be either planar or grated (as in FIGS. 3, 4, 7-13). In FIG. 15, first horn 802 is grated and second horn 806 is planar; emission is a free wave emitted as if from a waveguide. FIG. 16 illustrates an embodiment where both horns 802, 806 are grated; emission is in the form of Smith-Purcell radiation. FIG. 17 illustrates coupling of the slow mode in the output of a first grated horn 802 to an optical fiber 812 through frustrated total internal reflection. The output coupling efficiency, and thereby the cavity quality can be controlled by adjusting the gap distance 810 and selecting the grating profile. Second horn 806 acts as an output coupler and forms a highly collimated beam, such that coupling into instrumentation is efficient. Another advantage may be achieved in that output coupling is independent of cavity tuning (i.e., mirror position) and is adjustable. In an alternative embodiment in FIGS. 16 and 17, the profile of grating 803 can be chosen so that electron beam 14 can interact with a backward-wave electromagnetic mode bound to the horn vertex region and grating horn 802 can function as a backward-wave oscillator, without the necessity of mirror 814. The embodiments illustrated in FIGS. 15 through 17 can also function as light amplifiers or modulators by injecting a resonant light wave into the optical horn 806 not necessarily coaxial with the emitted wave 804.

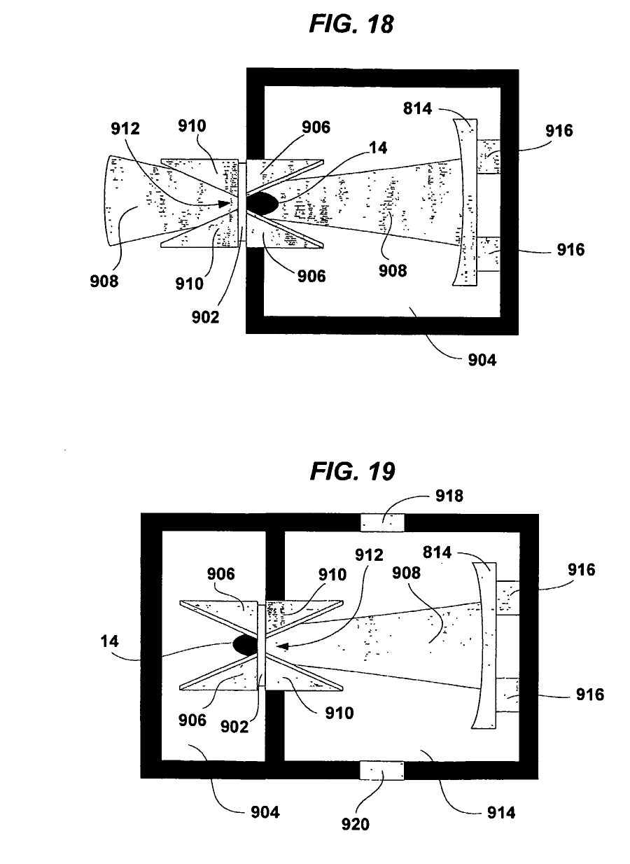

FIGS. 18-19 illustrate separation of two diametrically opposed horns by a window 902, which may for example be fabricated of 10 μm mica. In FIG. 18, electron beam 14 is formed in a first chamber 904, which may be evacuated. First chamber 904 may contain a first horn 906, a mirror 814 and mirror control actuators 916. Radiation 908 output from first horn 906 passes through window 902 to a second horn 910, which is outside of first chamber 904. Losses due to the window are minimal if second horn 910 is excited in the antisymmetrical mode relative to the first so that a field null exists at gap 912. FIG. 19 shows a schematic of a backward wave oscillator containing two diametrically opposed optical horns and configured as an intracavity absorption spectrometer. Electron beam 14 is formed in a first chamber 904, which may be evacuated. First chamber 904 contains a first horn 906, and radiation from first horn 906 passes through window 902 to a second horn 910, which is disposed in a second chamber 914. Second chamber 914 may, for example, be a sample chamber containing a sample inlet 918 and a sample outlet 920.

The use of second horn 806, 910 as an output coupler provides a number of advantages. For example, the spatial mode is a highly collimated beam when the mouth of second (output) horn 806, 910 has an equal length and width to eliminate astigmatism. Further, output coupling is independent of cavity tuning (i.e., mirror position) and provides for greater control and adjustability than traditional systems.

Certain changes may be made in the above methods, systems and devices without departing from the scope hereof. It is to be noted that all matter contained in the above description or shown in the accompanying drawings is to be interpreted as illustrative and not in a limiting sense.

What is claimed is:

1. A diffraction grating element, comprising:
a pair of optical horns, the optical horns diametrically opposed to one another such that radiation exiting a first horn enters a second horn,
wherein the first horn is ruled with a grating period, such that on electron beam interacting with the grating period produces terahertz radiation.

2. The diffraction grating element of claim 1, wherein the second horn is planar, such that radiation exiting the second horn forms a collimated free wave.

3. The diffraction grating element of claim 1, wherein the second horn is ruled with a second grating period, the grating period of the first horn and the grating period of the second horn oriented in phase, wherein radiation exiting the second horn forms Smith-Purcell radiation.

4. The diffraction grating element of claim 1, wherein the second horn contains an optical fiber for coupling the radiation through frustrated total internal reflection.

5. The diffraction grating element of claim 1, further comprising at least one chamber for isolating the first horn from the second horn.

6. The diffraction grating element of claim 5, wherein the chamber comprises a window such that the radiation enters the second horn through the window.

7. A system for generating FIR radiation, comprising:
an electron source for generating an electron beam; and
a pair of optical horns, the optical horns diametrically opposed to one another such that radiation exiting a first horn enters a second horn,
wherein the first horn is ruled with a grating period and interaction between the electron beam and the grating period produces the FIR radiation.

8. The system of claim 7, wherein the second horn is planar, such that radiation exiting the second horn forms a collimated free wave.

9. The system of claim 7, wherein the second horn is ruled with a second grating period, the grating period of the first horn and the grating period of the second horn oriented in phase, wherein radiation exiting the second horn forms Smith-Purcell radiation.

10. The system of claim 7, wherein the second horn contains an optical fiber for coupling the radiation through frustrated total internal reflection.

11. The system of claim 7, further comprising at least one chamber for isolating the first horn from the second horn.

12. The system of claim 11, wherein the chamber comprises a window such that the radiation enters the second horn through the window.

13. The system of claim 7, further comprising one or more optical elements for focusing the FIR radiation into a laser beam.

14. A method for generating FIR radiation, comprising:
generating an electron beam; and
focusing the electron beam to a pair of diametrically opposed optical horns, wherein one of the optical horns is ruled with a grating period and interaction between the electron beam and the grating period produces the FIR radiation.

15. The method of claim 14, further comprising coupling the FIR radiation into an optical fiber.

16. The method of claim 14, further comprising focusing the FIR radiation into a laser beam with one or more optical elements.
